(19) United States
(12) Patent Application Publication
(10) Pub. No.: US 2019/0288513 A1
(43) Pub. Date: Sep. 19, 2019

(54) DECENTRALIZED ENERGY MANAGEMENT UTILIZING BLOCKCHAIN TECHNOLOGY

(71) Applicant: NEC Laboratories America, Inc., Princeton, NJ (US)

(72) Inventors: Kiyoshi Nakayama, Santa Clara, CA (US); Ratnesh Sharma, Fremont, CA (US)

(21) Appl. No.: 16/257,399

(22) Filed: Jan. 25, 2019

Related U.S. Application Data
(60) Provisional application No. 62/642,049, filed on Mar. 13, 2018.

(51) Int. Cl. H02J 3/38; H04L 29/06; H04L 9/06; G06K 9/62; G06Q 20/40

(52) U.S. Cl. CPC H02J 3/381; H04L 63/1425; H04L 2209/38; G06K 9/6297; G06Q 20/401; H04L 9/0618

(57) ABSTRACT

A system and methods are provided for a decentralized transactive energy management. The method includes calculating, by a processor-device, power balancing at one of a plurality of nodes responsive to current statistics at the one of a plurality of nodes. The method also includes estimating, by the processor-device, a present energy demand for the one of a plurality of nodes responsive to the current statistics. The method additionally includes obtaining, by the processor-device, an amount of excess energy available another of the plurality of nodes. The method further includes optimizing, by the processor-device, a power flow between the one of the plurality of nodes and the another of the plurality of nodes to satisfy the present energy demand for the one of the plurality of nodes. The method also includes transferring the excess energy from the another of the plurality of nodes to the one of the plurality of nodes.

### RELATED APPLICATION INFORMATION

This application claims priority to 62/642,049, filed on Mar. 13, 2018, incorporated herein by reference herein its entirety.

### BACKGROUND

### Technical Field

The present invention relates to decentralized energy management and more particularly decentralized energy management utilizing blockchain technology.

### Description of the Related Art

Clean energy vendors and utility industries intensively are trying to explore the field of peer-to-peer (P2P) energy, which is an idea that power generation and consumption can be fully decentralized so that the customers with distributed generation capability could make the most use of their distributed and renewable energy resources without any centralized control authorities.

### SUMMARY

According to an aspect of the present invention, a computer-implemented method is provided for a decentralized transactive energy management system utilizing a smart contract in a blockchain. The method includes calculating, by a processor-device, power balancing at one of a plurality of nodes responsive to current statistics at the one of a plurality of nodes in the smart contract. The method also includes estimating, by the processor-device, a present energy demand in the smart contract for the one of a plurality of nodes responsive to the current statistics. The method additionally includes obtaining, by the processor-device, an amount of excess energy available another of the plurality of nodes. The method further includes optimizing, by the processor-device, a power flow between the one of the plurality of nodes and the another of the plurality of nodes to satisfy the present energy demand for the one of the plurality of nodes. The method also includes transferring the excess energy from the another of the plurality of nodes to the one of the plurality of nodes.

According to another aspect of the present invention, a computer-implemented method is provided for a decentralized transactive energy management system utilizing a smart contract in a blockchain. The method includes calculating, by a processor-device, power balancing at one of a plurality of nodes responsive to current statistics at the one of a plurality of nodes in the smart contract. The method also includes listing, by the processor-device, a set of strategies in the smart contract about an amount of available energy at the one of the plurality of nodes. The method additionally includes predicting, by the processor-device, a present energy demand needed by another of the plurality of nodes. The method further includes generating, by the processor-device, an optimal strategy from the set of strategies in the smart contract with a Markov representation model. The method also includes transferring the available energy from the one of the plurality of nodes to the another of the plurality of nodes according the optimal strategy.

According to yet another aspect of the present invention, a decentralized transactive energy management system utilizing a smart contract in a blockchain is provided. The decentralized transactive energy management system includes a processing system having a processor and memory coupled to the processor. The processing system is programmed to calculate power balancing at one of a plurality of nodes responsive to current statistics at the one of a plurality of nodes in the smart contract. The processing system is also programmed to list a set of strategies in the smart contract about an amount of available energy at the one of the plurality of nodes. The processing system is additionally programmed to predict a present energy demand needed by another of the plurality of nodes. The processing system is further programmed to generate an optimal strategy from the set of strategies in the smart contract with a Markov representation model. The processing system is also programmed to transfer the available energy from the one of the plurality of nodes to the another of the plurality of nodes according the optimal strategy.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is an exemplary environment utilizing the transactive energy management system, in accordance with the present invention;

FIG. 2 is a block/flow diagram illustrating a transactive energy management system, in accordance with the present invention;

FIG. 3 is a block/flow diagram illustrating a transactive energy management system, in accordance with the present invention;

FIG. 4 is a block/flow diagram illustrating a transactive energy management system, in accordance with the present invention;

FIG. 5 is a block diagram illustrating a processing system, in accordance with an embodiment of the present invention;

FIG. 6 is a flow diagram illustrating a method for transactive energy management, in accordance with an embodiment of the present invention; and

FIG. 7 is a flow diagram illustrating a method for transactive energy management, in accordance with an embodiment of the present invention.

### DETAILED DESCRIPTION OF PREFERRED EMBODIMENTS

Embodiments in accordance with the present invention provide methods and systems for transactive energy management utilizing blockchain technology. Further, the transactive energy management system can autonomously decide the optimum amount of energy sold to other consumers and the price for which the energy is sold. The transactive energy management system can effectively calculate the utilization of batteries by considering the benefits to both the consumers and the generators in view of a variety of physical constraints on the utilities and power systems, battery properties, and prediction of energy consumption and generation with a sound framework to optimize the benefits.

Blockchain supports the concept of decentralized databases, contracts, and transactions so that any centralized server is no longer needed to keep track of all the records of operations and transactions. The smart contract mechanism of the blockchain technology can keep track of the transactions of energy exchanges between consumers and generators.

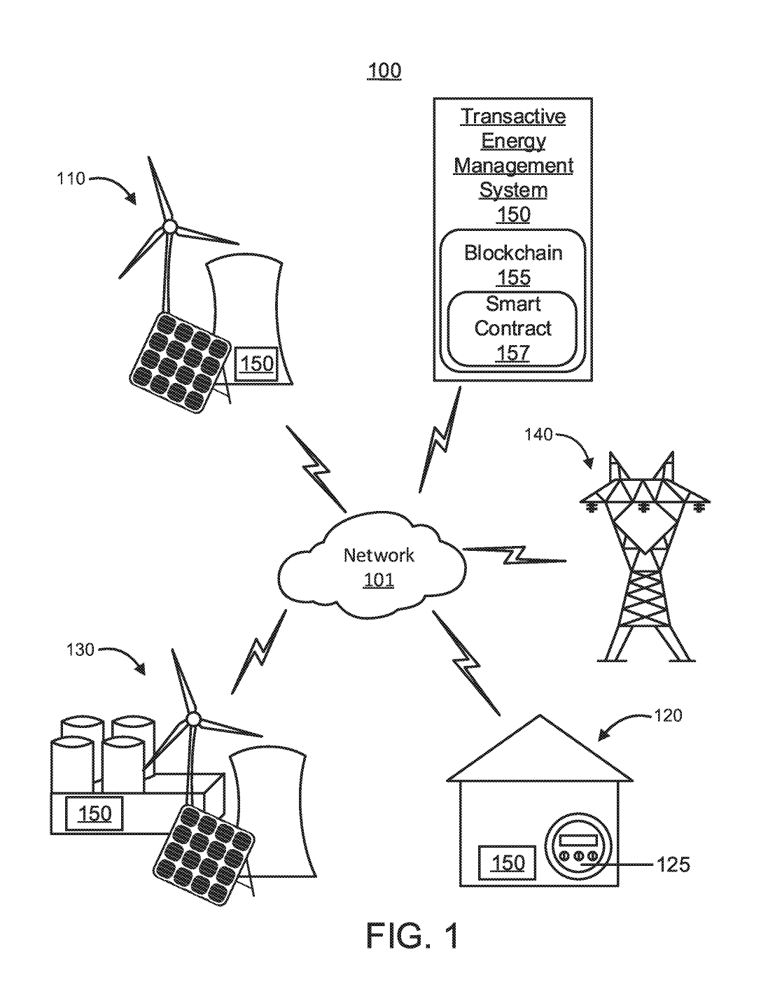

Referring now to the drawings in which like numerals represent the same or similar elements and initially to FIG. 1, an exemplary environment 100 to which the present invention can be applied is shown, according to an embodiment of the present invention. In the energy management domain, a transactive energy management system 150 can utilize a blockchain 155 since the blockchain 155 could digitally link up millions of decentralized energy devices including distributed generators 110 and batteries to record their outputs and transactions even at the residential level over a network 101. Proliferation of active grid-edge devices and systems can change the operational and business model of the utilities and/or grid 140. In microgrids and smart buildings, the owners and operators of those systems can generally be referred to as prosumers 130 who are consumers with Distributed Energy Resources (DERs) with Distributed Generation (DG) systems, e.g., photovoltaic (PV) systems, wind turbine systems, and energy storage systems. There is demand from the prosumers 130 for regulators to enable, and utilities 140 to accommodate, energy market-based transactions.

The blockchain 155 mechanisms can permit the prosumers 130 to exchange their energy based on a transactive energy framework without central authorities, e.g., independent system operators (ISO). Transactive energy encourages consumers 120 and generators 110 to control their resources and devices based on the market, which brings the maximum benefit to both of consumers 120 and the generators 110. The energy transaction can be decentralized, and each of the prosumers 130 can directly bid to send and/or receive energy from each other. A promising area for the blockchain 155 technology can be in P2P trading, where owners of DG, e.g., the prosumers 130 and the generators 110, can sell excess generation to the consumers 120.

Profits can be maximized by transactive energy management among the consumers 120 and the generators 110 without central authority based on secured and consistent decentralized interactions using a smart contract 157 framework in the blockchain 155 technology. Without the central controlling authority, the consumers 120 and the generators 110 can optimize the transactions of locally produced energies to satisfy local loads, be sold to other consumers 120, or store in a battery for future use. Commercial and industry (C&I) consumers 120 can minimize their cost of Demand Charge (DC) that depends on the maximum load during some peak periods, so called peak, partial peak, and anytime DC periods, by getting energy not from the utilities 140 but from the generators 110. All the energy transactions can be decentralized and each of the prosumers 130 who have generation capability can decide their available energy and unit prices to make selling energy directly to the consumers 120 feasible.

In particular, for the consumers 120, the cost of receiving power from the utilities 140 can be minimized including the costs of Time of Use (TOU) and Demand Charge if applicable as well as the cost of energy obtained from other generators such as the prosumers 130 or the generators 110. On the other hand, for the energy generator side, the amount of energy sold to the consumers 120 and to the wholesale market can be maximized. The transactive energy management system 150 can rely upon the physical constraints of the power balancing of energy consumption and generation, battery properties, and power system and grid properties.

The blockchain 155 technology utilized in the transactive energy management system 150 enables a decentralized framework without aggregators or central coordination, which allows the prosumers 130 to decide the price of the available energy in a more flexible manner.

An autonomous decentralized transactive energy management system 150 utilizing the smart contract 157 framework in the blockchain 155 technology for maximizing the benefit of the generators 110 with excess energy production to be sold to the utilities 140 and/or the consumers 120 as well as minimizing the cost to the consumers 120 buying energy from the utilities 140 and/or neighbors. A three-layer mechanism with 1) a preliminary phase about analysis of current updated energy data such as load and PV generation to create the potential strategies for selling energy amount and its price for the generators 110 as well as the amount of needed energy for the consumers 120, 2) a decision phase about optimization on the strategies that the generators 110 have listed up as well as consumers' efficient energy delivery procedure considering the status of the other nodes, and 3) a verification phase of transactions that happened during the pre-determined time interval, all based on the decentralized framework implemented with the smart contract 157 of the blockchain 155 technology.

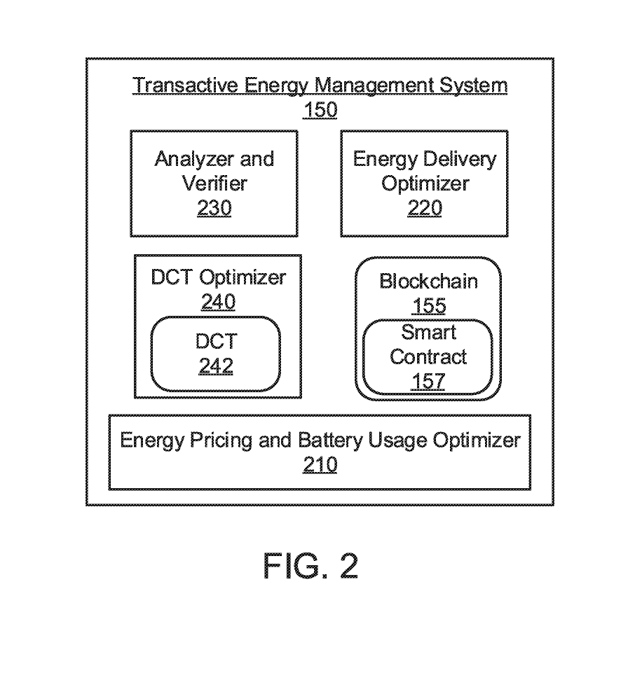

Referring to FIG. 2, a block/flow diagram showing the transactive energy management system 150, in accordance with an embodiment of the present invention. To enable the three-layer mechanism, an autonomous decentralized transactive energy management system 150 that consists of energy pricing and battery usage optimizer 210, energy delivery optimizer 220, and analyzer and verifier 230 of meter data for transaction verification is provided.

The pricing and battery usage optimizer 210 calculates the amount of energy available and the energies price for the consumers 120 based on available energy information and prediction of load and renewable generation of other nodes. If the generator 110 is a C&I customer, the generator 110 needs to first satisfy their demand charge thresholds to minimize the total energy cost and have some backup in storage. Then, the generator 110 can list up the possible strategies for the amount and price of the available energy sold to others as well as its battery usage. The possible strategies can be mapped to a Markov representation to extract the state that brings the highest benefit to the generator 110.

The energy delivery optimizer 220 delivers energy based on a balancing equation of excess and needed energies. The energy delivery optimizer 220 can calculate the amount of needed energy considering the demand charge threshold and battery utilization, conducts network topology analysis to estimate power loss, and solves power flow analysis to receive energy from generation nodes.

The analyzer and verifier 230 verifies transactions to be chained in the blockchain 155, which uses meter data from smart meters 125 to conduct power flow analysis with injected energies and thorough battery profile analyses to validate the State of Charge (SOC) and power outputs to satisfy their energy needs. Intelligent anomaly detections can be integrated for further verification of meter data. Furthermore, efficient distributed consensus solutions can be done in case some nodes reported contradictory information to the network.

The blockchain 155 technology can be utilized to solve an optimal power flow to minimize the cost from the generators 110, this unique solution can minimize the cost to the consumers 120 including demand charge as well as maximize the benefit for the generators 110 using the blockchain 155 technology.

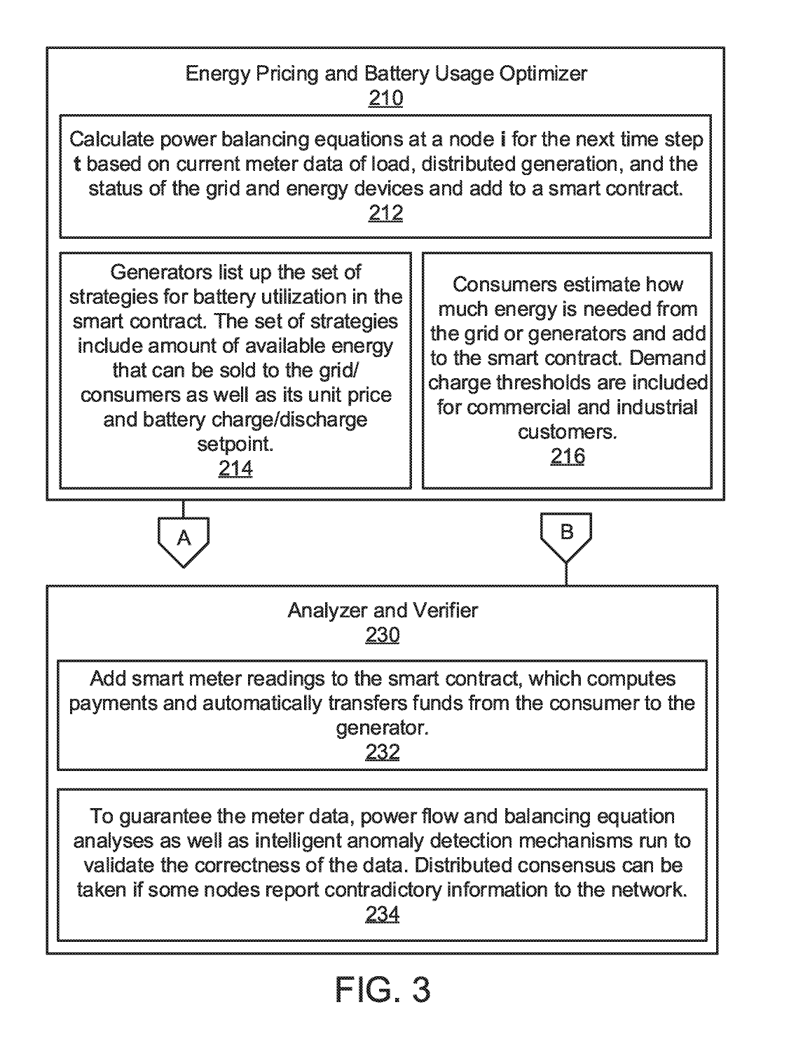

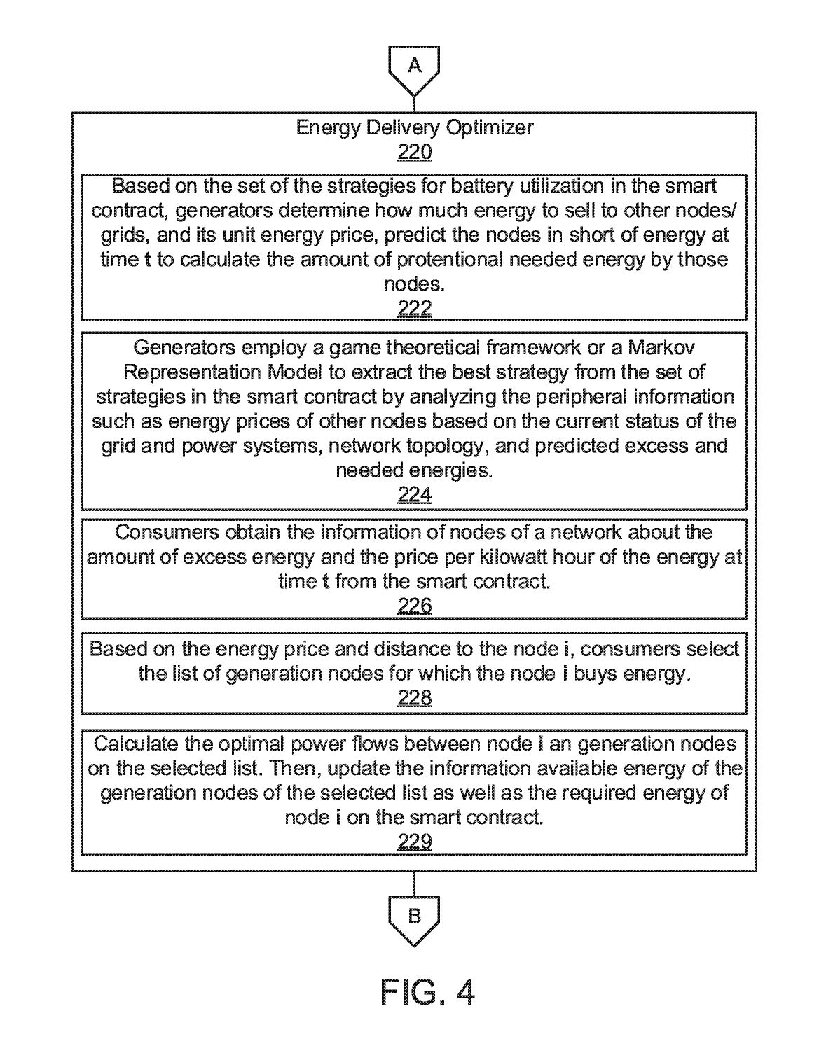

Referring to FIG. 3 and FIG. 4, a block/flow diagram showing the transactive energy management system 150, in accordance with an embodiment of the present invention. The transactive energy management system 150 can include the energy pricing and battery usage optimizer 210. The energy pricing and battery usage optimizer 210 can add information to the smart contract 157 to plan policies for the next time step t. The smart contract 157 can be used as a system status tracker. Thus, all nodes can send out the information to share available excess energy and needed energy at any time to the smart contract 157. At each time t during operation the generators 110 or the consumers 120 can fluctuate because of the prosumers 130 have both the capability of producing and consuming energy. Therefore, the classification of the consumers 120 and the generators 110 depends on the balance of energy consumption and generation such as PV output. For consumers 120, the energy pricing and battery usage optimizer 210 can estimate how much energy is needed 216 from the utilities 140 or the generators 110. For the generators 110, the energy pricing and battery usage optimizer 210 can list up a set of strategies about an amount of available energy that can be sold to the utilities 140 or the consumers 120 as well as the unit energy price and battery charge/discharge setpoint 214.

The energy pricing and battery usage optimizer 210 can calculate power equations 212 based on the list of strategies of available energy to the other nodes and the grid 140, the energies price, and battery usage for the generators 120 as well as needed energy for the consumers 110. The needed energy being about how much energy a node needs to receive from the other nodes or the utility 140. For calculation of available and needed energy, in case the consumer 110 is C&I customer, the demand charge threshold (DCT) 242 optimization is integrated, where on the basis of the monthly prediction of load and renewable generation, a DCT optimizer 240 decides the threshold of the net demand by which the peaks are curtailed using battery to minimize the demand charge cost. The DCT 242 is based on a thorough analysis of the battery behavior and its state of charge profile. In addition, getting energy from other nodes could also be a way to curtail further peak demands and needs to be considered when creating the list of strategies to be published in the smart contract 157. The consumers 120 and the generators 110 information added to the smart contract 157 can be utilized by the energy delivery optimizer 220.

The energy delivery optimizer 220 can make decisions responsive to the smart contract 157 at time t using information of the other nodes. Based on the information posted or processed in the smart contract 157, the energy delivery optimizer 220 decides on the optimized values for incentives for energy to be sold and how much power each of the consumers 120 should receive from which of the generators 110. In one embodiment, the consumers 120 and the generators 110 permit the energy delivery optimizer 220 to automatically buy and sell energy in the optimized process 222. In another embodiment, the consumers 120 and the generators 110 check and approve the optimized price info before the energy delivery optimizer 220 proceeds with the transactions of energies. For each of the consumers 120 that is short of energy, the energy delivery optimizer 220 decides the energy flow to the consumers 120 to satisfy the energy needs 229. The energy delivery optimizer 220 looks at which of the neighboring nodes have enough inexpensive energy to feed the node, all of the energy to the node comes from neighbors 226. If there is not enough energy, the energy delivery optimizer 220 gets another inexpensive energy from neighbors of the neighbors 228. After repeating this procedure, each node decides which of the generators 110 and the amount of energy it receives from the generators 110. For the generators 110 that know the energy purchasing strategy of the consumers 120, the energy delivery optimizer 220 can utilize a Markov representation model to extract the best strategy based on predictions of load and renewable generation such as PV 224.

The energy delivery optimizer 220 can define two objectives for the consumers 120 and the generators 110 that can be solved and implemented on the smart contract 157 framework in the blockchain 155. The energy delivery optimizer 220 can include the two types of analysis for the consumers 120 and the generators 110 below.

The consumers 120 side objective of the energy delivery optimizer 220 for each customer node j at each time t can be

$$min {\sum }_{i ∈ G} {p}_{i} ( t ) {f}_{ij} ( t ) + {p}^{g} ( t ) {e}_{j}^{g} ( t ) + {DC}_{j}$$

where G is a list of the generators at time t, pᵢ(t) is the price of energy per kWh of a generation node i, fᵢⱼ(t) denotes the energy flow from node i to j, p^{g}(t) is the price of grid power, eⱼ^{g}(t) is the energy from the grid 140, and DCⱼ is the demand charge of the month. The energy delivery optimizer 220 utilizes the DCT 242 if the consumers 120 are the commercial and industrial customers. Integration of the DCT 242 in the calculation makes the procedure unique which is based on the monthly load and DG prediction to obtain an optimal DCT 242.

To achieve the objective, the energy delivery optimizer 220 can iteratively pick up the generators 110 with inexpensive energy that are a closer distance to the consumers 120. Let Eⱼ^{c} be the current energy from the generators 110 initialized as Eⱼ^{c}=0. Eⱼ^{R}(t) is the needed energy of node j at time t. Let G be a list of the generators 110 at time t. Exclude the nodes from G where the available energy price is higher than the grid power price. The available energy of node iϵG at time t is denoted as Eᵢ^{a}(t).

While the list of the generators 110 G is not empty, pick up a node i from G with a minimum price and a minimum distance. If Eⱼ^{R}(t)−Eⱼ^{c}>Eᵢ^{a}(t), then conduct Eⱼ^{c}←Eⱼ^{c}+Eᵢ^{a}(t), fᵢ^{j}(t)=Eᵢ^{a}(t), Eᵢ^{a}(t)=0, and remove i from G. Otherwise, Eⱼ^{c}=Eⱼ^{R}(t), fᵢⱼ(t)=Eⱼ^{R}(t)=Eⱼ^{R}(t)−Eⱼ^{c}, Eᵢ^{a}(t)=Eᵢ^{a}(t)−(Eⱼ^{R}(t)−Eⱼ^{c}), and break the loop. After this loop, if Eⱼ^{c} is not Eⱼ^{R}(t), the energy from the grid 140 is eⱼ^{g}(t)=Eⱼ^{R}(t)−Eⱼ^{c}.

The generators 110 side objective of the energy delivery optimizer 220 for each generator node i at each time t can be

$$max {\sum }_{j ∈ C} {p}_{i} ( t ) {f}_{ij} ( t ) + {p}^{f} ( t ) {e}_{i}^{f} ( t )$$

where in addition to the definitions above, C is a list of the consumers at time t, p^{f}(t) is feed-in tariff and eᵢ^{f}(t) is energy sold to the grid 140 from the node i. The unique idea lies in the method of how to decide the optimal price for the node i at time t. The price should range as p^{f}(t)<pᵢ(t)<p^{g}(t) unless there is something emergent to make the grid 140 unstable.

First, the node i predicts the load of the network nodes. Based on the price information of the other nodes, the energy delivery optimizer 220 adapts the Markov chain model to decide the optimal price where each state to be considered as a price. The generators 110 have a set of policies/strategies for battery charge {sₖ^{b}}, amount of energy sold to the grid 140 and other nodes {sₗ^{e}}, and the energies price {sₙ^{p}}. Each policy represents a state of Markov representation such as (sₗ^{b}, sₘ^{e}, sₙ^{p}). The generators 110 use exactly the same strategy as the algorithm that the consumers 120 uses to minimize the cost, to estimate the benefit of the generators 110. After thorough simulation with all the possible states of the Markov representation, the generators 110 will finalize the value of the price, battery charge/discharge, and the amount of available energy 224. The data can be sent to the smart contract 157 to be utilized by the analyzer and verifier 230.

The analyzer and verifier 230 can be called after the operation of the grid 140 and power systems is finished to verify the smart contract 157 to ensure the smart contract 157 correctly recorded all the transactions among nodes the occurred at time t. All the violated transactions are not included in the blockchain 155. Also, verification can occur for how much energy was sent out to the utilities 140 and other nodes as well as how much energy the consumers 120 received from the generators 110. If there is any discrepancy in smart meter 225 data shared in the smart contract 157, power flow and balancing equation analyses as well as intelligent anomaly detection can be utilized to detect the cause of failures or attacks 234. Furthermore, distributed consensus can take place in cases where some nodes report contradictory information to the smart contract 157.

The analyzer and verifier 230 can provide an analysis scheme for transaction verification. The validation process of how much energy exchanged among nodes and or sent to the utility 140, the transactive energy management system 150 has the analysis mechanism of actual energy exchanges based on the information provided by all the nodes or a selected group of nodes from smart meter 125 readings 232. In case of contradiction among analysis and calculation, the analysis results, which are based on intelligent anomaly detection using one step prediction approach with injected power data, from more than half of the nodes will be trusted and shared by all the nodes as a transaction element of a block 234.

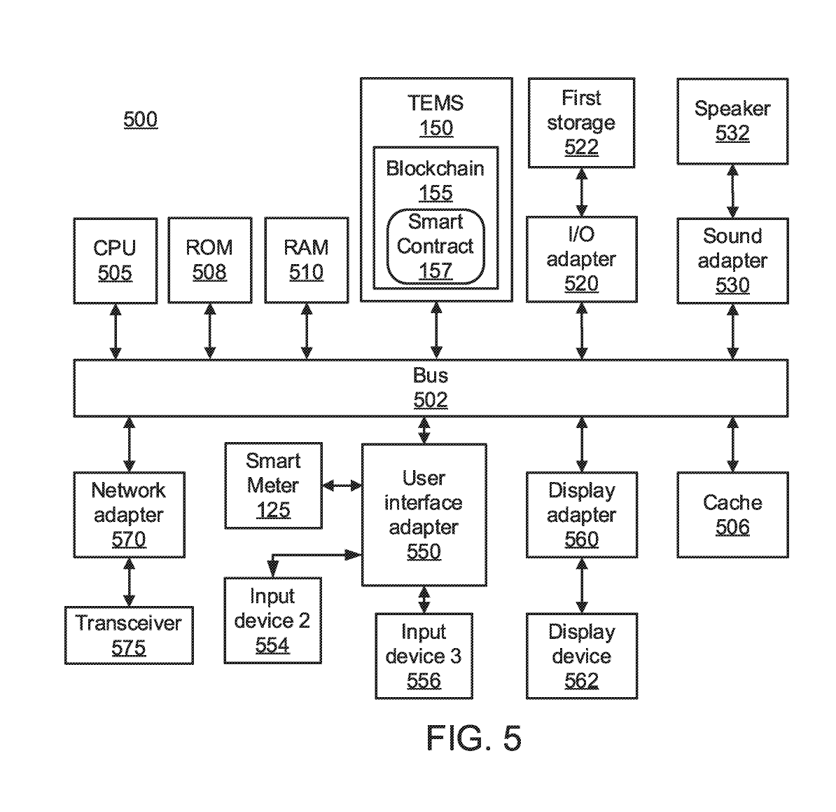

Referring to FIG. 5, an exemplary processing system 500 is shown which may represent a server or a network device, in accordance with an embodiment of the present invention. The processing system 500 includes at least one processor (CPU) 505 operatively coupled to other components via a system bus 502. The processing system 500 includes the transactive energy management system 150 operatively coupled to the other components via the system bus 502. A cache 506, a Read Only Memory (ROM) 508, a Random Access Memory (RAM) 510, an input/output (I/O) adapter 520, a sound adapter 530, a network adapter 570, a user interface adapter 550, and a display adapter 560, are operatively coupled to the system bus 502.

A first storage device 522 is operatively coupled to system bus 502 by the I/O adapter 520. The storage device 522 can be any of a disk storage device (e.g., a magnetic or optical disk storage device), a solid state magnetic device, and so forth.

A speaker 552 may be operatively coupled to system bus 502 by the sound adapter 550. A transceiver 575 is operatively coupled to system bus 502 by network adapter 570. A display device 562 is operatively coupled to system bus 502 by display adapter 560.

The smart meter 125, a second user input device 554, and a third user input device 556 are operatively coupled to system bus 502 by user interface adapter 550. The smart meter 125 can provide usage information for a current location, whether the current location is one of the generators 110 or the consumers 120, to the network 101 through the network adapter 570. The user input devices 554 and 556 can be any of a sensor, a keyboard, a mouse, a keypad, a joystick, an image capture device, a motion sensing device, a power measurement device, a microphone, a device incorporating the functionality of at least two of the preceding devices, and so forth. Of course, other types of input devices can also be used. The user input devices 554 and 556 can be the same type of user input device or different types of user input devices. The user input devices 554 and 556 are used to input and output information to and from system 500.

The transactive energy management system 150 can be in communication with both the generators 110 and the consumers 120 through the network adapter 570 to optimally provide energy from the generators 110 to the consumers 120. The transactive energy management system 150 can utilize blockchain 155 technology with the smart contract 157 for this purpose. The transactive energy management system 150 can store the smart contract 157 in the first storage device 522 as a local version that is continually updated by the generators 110 and the consumers 120 over the network 101. The transactive energy management system 150 can release energy to the consumers 120 and pay the generators 110 for used energy. The transactive energy management system 150 can utilize the analyzer and verifier 230 to audit the smart contract 157 for accuracy.

Of course, the processing system 500 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present invention provided herein.

Moreover, it is to be appreciated that environment 100 described above with respect to FIG. 1 is an environment for implementing respective embodiments of the present invention. Part or all of processing system 500 may be implemented in one or more of the elements of environment 100.

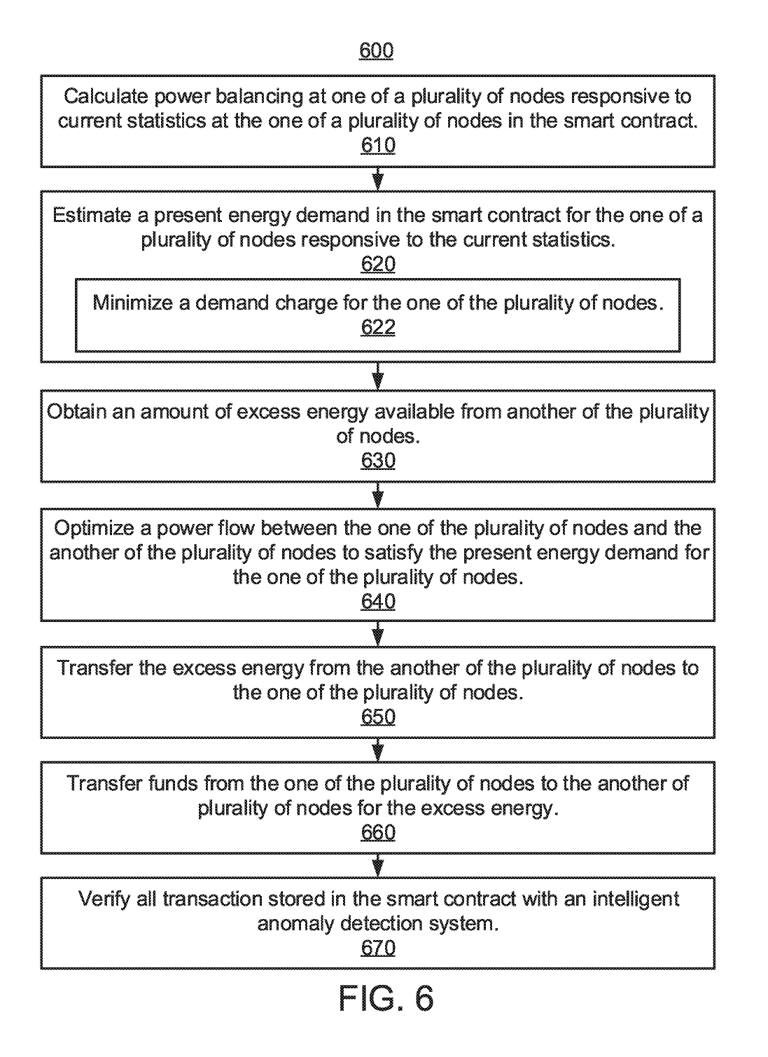

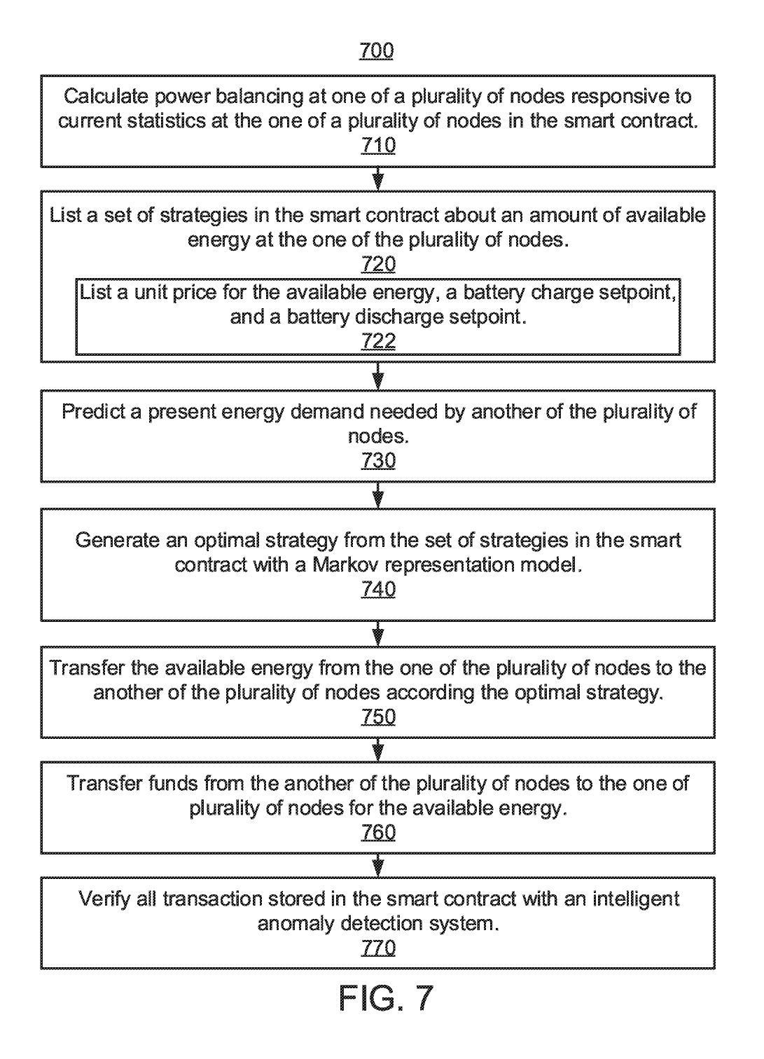

Further, it is to be appreciated that processing system 500 may perform at least part of the method described herein including, for example, at least part of method 600 of FIG. 6. And/or at least part of method 700 of FIG. 7.

Referring to FIG. 6, methods for transactive energy management with a smart contract in a blockchain are illustratively shown and described. In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In block 610, power balancing is calculated at one of a plurality of nodes responsive to current statistics at the one of a plurality of nodes in the smart contract. In block 620, a present energy demand is estimated in the smart contract for the one of a plurality of nodes responsive to the current statistics. In block 622, a demand charge is minimized for the one of the plurality of nodes. In block 630, an amount of excess energy available from another of the plurality of nodes is obtained. In block 640, a power flow between the one of the plurality of nodes and the another of the plurality of nodes is optimized to satisfy the present energy demand for the one of the plurality of nodes. In block 650, the excess energy is transferred from the another of the plurality of nodes to the one of the plurality of nodes. In block 660, funds are transferred from the one of the plurality of nodes to the another of plurality of nodes for the excess energy. In block 670, all transaction stored in the smart contract are verified with an intelligent anomaly detection system.

Referring to FIG. 7, methods for transactive energy management with a smart contract in a blockchain are illustratively shown and described. In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In block 710, power balancing is calculated at one of a plurality of nodes responsive to current statistics at the one of a plurality of nodes in the smart contract. In block 720, a set of strategies about an amount of available energy at the one of the plurality of nodes are listed in the smart contract. In block 722, a unit price for the available energy, a battery charge setpoint, and a battery discharge setpoint are listed. In block 730, a present energy demand needed by another of the plurality of nodes is predicted. In block 740, an optimal strategy is generated from the set of strategies in the smart contract with a Markov representation model. In block 750, the available energy is transferred from the one of the plurality of nodes to the another of the plurality of nodes according the optimal strategy. In block 760, funds are transferred from the another of the plurality of nodes to the one of plurality of nodes for the available energy. In block 770, all transaction stored in the smart contract are verified with an intelligent anomaly detection system.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity needed by the patent laws, what is claimed and desired protected by Letters Patent is set forth in the appended claims.

What is claimed is:

1. A computer-implemented method for a decentralized transactive energy management system utilizing a smart contract in a blockchain, the method comprising:
calculating, by a processor-device, power balancing at one of a plurality of nodes responsive to current statistics at the one of a plurality of nodes in the smart contract;
estimating, by the processor-device, a present energy demand in the smart contract for the one of a plurality of nodes responsive to the current statistics;
obtaining, by the processor-device, an amount of excess energy available from another of the plurality of nodes;
optimizing, by the processor-device, a power flow between the one of the plurality of nodes and the another of the plurality of nodes to satisfy the present energy demand for the one of the plurality of nodes; and
transferring the excess energy from the another of the plurality of nodes to the one of the plurality of nodes.

2. The computer-implemented method as recited in claim 1, wherein the current statistics can be selected from the group consisting of a current meter data of load at the one of the plurality of nodes, a distributed generation at the one of the plurality of nodes, and a status of the grid and energy devices.

3. The computer-implemented method as recited in claim 1, wherein the estimating includes minimizing a demand charge for the one of the plurality of nodes.

4. The computer-implemented method as recited in claim 1, wherein obtaining includes obtaining a price per kilowatt hour for the excess energy.

5. The computer-implemented method as recited in claim 1, further includes transferring funds from the one of the plurality of nodes to the another of plurality of nodes for the excess energy.

6. The computer-implemented method as recited in claim 1, further includes storing all transactions in the smart contract in the blockchain.

7. The computer-implemented method as recited in claim 6, further includes verifying all transaction stored in the smart contract with an intelligent anomaly detection system.

8. The computer-implemented method as recited in claim 6, further includes verifying all transaction stored in the smart contract with power flow and power balancing analyses.

9. The computer-implemented method as recited in claim 1, further includes updating the smart contract with available energy at the another one of the plurality of nodes.

10. A computer-implemented method for a decentralized transactive energy management system utilizing a smart contract in a blockchain, the method comprising:
calculating, by a processor-device, power balancing at one of a plurality of nodes responsive to current statistics at the one of a plurality of nodes in the smart contract;
listing, by the processor-device, a set of strategies in the smart contract about an amount of available energy at the one of the plurality of nodes;
predicting, by the processor-device, a present energy demand needed by another of the plurality of nodes;
generating, by the processor-device, an optimal strategy from the set of strategies in the smart contract with a Markov representation model; and
transferring the available energy from the one of the plurality of nodes to the another of the plurality of nodes according the optimal strategy.

11. The computer-implemented method as recited in claim 10, wherein the current statistics can be selected from the group consisting of a current meter data of load at the another of the plurality of nodes, a distributed generation at the one of the plurality of nodes, and a status of the grid and energy devices.

12. The computer-implemented method as recited in claim 10, wherein the listing includes listing a unit price for the available energy.

13. The computer-implemented method as recited in claim 10, wherein the listing includes listing a battery charge setpoint and a battery discharge setpoint.

14. The computer-implemented method as recited in claim 10, further includes transferring funds from the another of the plurality of nodes to the one of plurality of nodes for the available energy.

15. The computer-implemented method as recited in claim 10, further includes storing all transactions in the smart contract in the blockchain.

16. The computer-implemented method as recited in claim 15, further includes verifying all transaction stored in the smart contract with an intelligent anomaly detection system.

17. The computer-implemented method as recited in claim 15, further includes verifying all transaction stored in the smart contract with power flow and power balancing analyses.

18. The computer-implemented method as recited in claim 10, further includes updating the smart contract with available energy at the one of the plurality of nodes.

19. The computer-implemented method as recited in claim 10, wherein generating includes analyzing information selected from the group consisting of energy prices at node responsive to a current status of a grid and power systems, a network topology, predicted excess energies, and predicted energy demand.

20. A decentralized transactive energy management system utilizing a smart contract in a blockchain, the decentralized transactive energy management system comprising:
a processing system including a processor and memory coupled to the processor, the processing system programmed to:
calculate power balancing at one of a plurality of nodes responsive to current statistics at the one of a plurality of nodes in the smart contract;
list a set of strategies in the smart contract about an amount of available energy at the one of the plurality of nodes;
predict a present energy demand needed by another of the plurality of nodes;
generate an optimal strategy from the set of strategies in the smart contract with a Markov representation model; and
transfer the available energy from the one of the plurality of nodes to the another of the plurality of nodes according the optimal strategy.
